(19) United States
(12) Patent Application Publication
(10) Pub. No.: US 2018/0117958 A1
(43) Pub. Date: May 3, 2018

(54) VARIABLE CROSS-SECTIONAL PROFILE WHEEL RIM

(71) Applicant: Princeton Carbon Works, Princeton, NJ (US)

(72) Inventors: Harrison James Macris, Mystic, CT (US); Bradley Page Werntz, Cambridge, MA (US)

(21) Appl. No.: 15/803,658

(22) Filed: Nov. 3, 2017

Related U.S. Application Data
(60) Provisional application No. 62/417,053, filed on Nov. 3, 2016.

(51) Int. Cl. B60B 1/04; B60B 5/02; B60B 1/00; B60B 21/08; B60B 21/06; B60B 21/02

(52) U.S. Cl. CPC B60B 1/04; B60B 5/02; B60B 1/003; B60B 21/08; B60B 2900/311; B60B 21/02; B60B 2360/3416; B60B 2900/1216; B60B 21/062

(57) ABSTRACT

An improved wheel rim is provided that has a varying cross-sectional profile in the axial direction, the radial direction, or both that is not limited to any specific cross-section shape, number of repeating patterns, construction material or style, with the cross-sectional profile optionally varying either uniformly or non-uniformly.

### CROSS-REFERENCE TO RELATED APPLICATION

This application is a non-provisional patent application of and claims the benefit to U.S. Provisional Patent Application No. 62/417,053, filed Nov. 3, 2016, and titled “Variable Cross-Sectional Profile Wheel Rim,” the disclosure of which is hereby incorporated herein by reference in its entirety.

### FIELD

The disclosure relates to wheels, more specifically wheels often used on vehicles intended to be powered by humans, such as bicycles, tricycles, wheel chairs, among other human powered or mechanically powered vehicles.

### BACKGROUND

Standard bicycle wheels can be a variety of sizes and are typically made out of an aluminum alloy or a variety of composite materials. Both light weight and aerodynamic flow are both essential to high performance wheels.

Typical wheels include an outer rim, a plurality of spokes, and a central hub. The central hub is attached to the bike and contains the bearings that allow the wheel to spin freely. The hub is connected to the outer rim through the use of spokes, which can exist in variety of numbers, shapes, and materials. The outer rim is what the bicycle tire is seated on in what is referred to as either “clincher” or “tubular” style fastening.

### SUMMARY

A wheel for a human powered vehicle includes a rim having a variable cross-section and including a first side defining a first inner edge and a first outer edge, and a second side defining a second inner edge and a second outer edge. The first inner edge and the second inner edge of the first and second sides, respectively, may define a spoke engaging portion having a profile defined by a substantially sinusoidal waveform superimposed on a circle. The wheel may also include a hub and a plurality of spokes engaged with the spoke engaging portion and the hub to secure the variable cross-section rim to the hub.

The spoke engaging portion may define peaks extending radially towards the hub, and the peaks may conform to the substantially sinusoidal waveform. The peaks may have a height, relative to adjacent troughs, between about 1 mm and about 7 mm. The peaks may have a height, relative to adjacent troughs, between about 1 mm and about 5 mm.

The wheel may include more peaks than spokes. The rim may be formed of or include carbon fiber. The first and second sides of the rim may be part of a unitary carbon fiber structure.

The wheel may further include a metal hoop defining a braking surface and configured to engage a tire. The spoke engaging portion may define 24 peaks of equal height. The wheel may include 18 spokes.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 depicts a portion of an example wheel having a variable cross-section rim and having the same number of spokes as there are peaks on the rim.

FIG. 2 depicts a portion of a bicycle using the rim of FIG. 1.

FIG. 3 depicts another view of the rim of FIG. 1.

FIG. 4 depicts another view of a portion of a bicycle using the rim of FIG. 1.

FIG. 5 depicts a portion of a front wheel having a variable cross-section rim and having fewer spokes than there are peaks on the rim.

FIGS. 6-7 depict example airflow paths over the rim of FIG. 1.

FIG. 8 depicts example cross-sectional and side views of the rim of FIG. 1.

### DETAILED DESCRIPTION

The following description of particular aspect(s) is merely exemplary in nature and is in no way intended to limit the scope of the invention, its application, or uses, which may, of course, vary. The disclosure is presented with relation to the non-limiting definitions and terminology included herein. These definitions and terminology are not designed to function as a limitation on the scope or practice of the invention but are presented for illustrative and descriptive purposes only. While the wheels are described an order of specific portions or using specific materials, it is appreciated that portions or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Provided is a wheel with improved aerodynamic capability and improved stability. The invention has utility as a rolling apparatus such as a rim used on a wheeled vehicle, optionally a bicycle, tricycle, or wheelchair.

An improved wheel is provided that includes a variable cross-sectional profile rim. The cross-sectional profile optionally varies in depth (radial direction), width (axial direction), or both, optionally allowing a non-uniform shape. The cross-section optionally varies in a systematic, radially-symmetric, and/or patterned way such that when spinning the wheel remains balanced. There can be any number of repeating variances.

There are several aerodynamic and structural advantages to a variable cross-sectional profile bicycle rim. The variable cross-sectional profile bicycle rim can be manufactured of any suitable material, including, but not limited to, composites, polymers, ferrous and non-ferrous metals and alloys. Joining or securing the rim to the central hub can be any form of spoke or other support member, in any shape, size, or material, that will be suitably strong to support the wheel, bicycle, and rider.

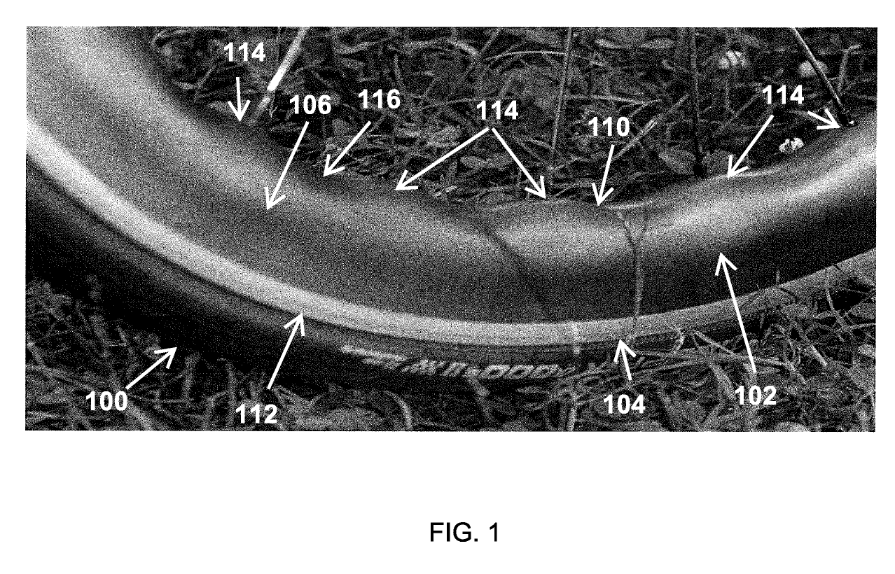

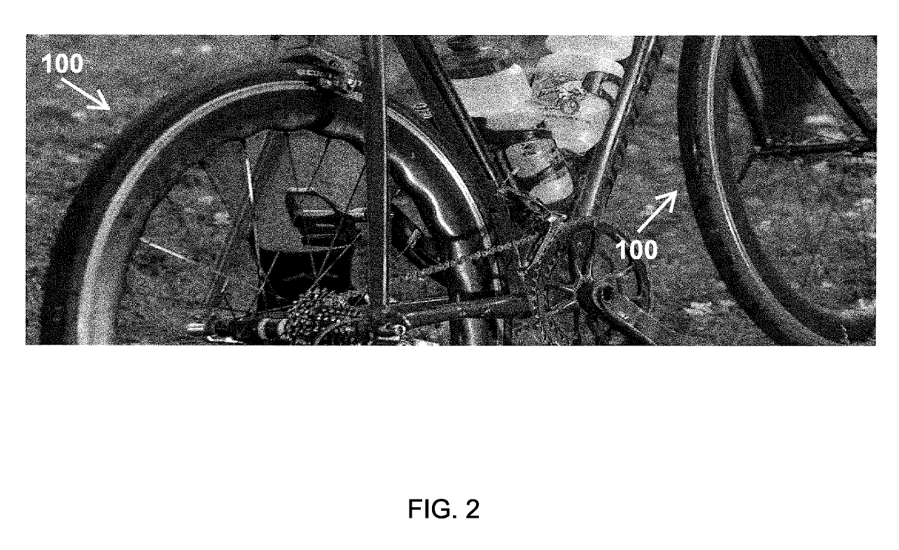

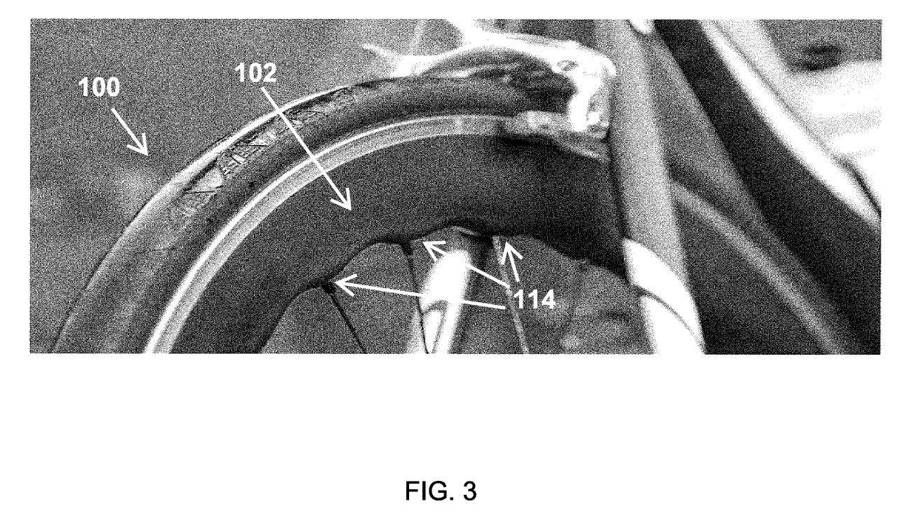

With reference to FIGS. 1-5, a wheel 100 is provided that includes a variable cross-section rim 102 that includes a tire engaging portion 104 at or proximal to an outer diameter of the rim, a first surface or side 106 at least partially defining an inner edge 110, and an outer edge 112 whereby the outer edge 112 is in contact with or at least partially defines the tire engaging portion, and the inner edge 110 is in contact with or at least partially defines a spoke engaging portion. The rim 102 also includes a second surface or side on the opposite side of the rim 102 and having substantially the same features as the first side 106. For example, the inner edges of the first and second sides may be in contact with or define the spoke engaging portion of the rim, and the outer edges may be in contact with or define the tire engaging portion. Together, the first and second sides may define substantially the entire rim 102. In some cases, another rim component may be included that defines the tire engaging portion and optionally a braking surface. For example, a metal hoop may be attached to or otherwise integrated with the first and second sides to define a complete rim. In this case, the outer edges of the first and second sides may engage with or contact an inner edge of the metal hoop. As used herein the term “edge” is not limited to substantially sharp corners, but may be a transitional point from one portion to another.

The spoke engaging portion includes a plurality of radially extending portions or peaks 114 extending above adjacent troughs 116 and extending generally radially toward a wheel center. The radially extending portions form an undulating shape along at least a part of the spoke engaging portion. The undulating shape of the spoke engaging portion forms the variable cross-section aspect to the rim whereby cross-sections at the peaks 114 forms a longer or larger rim cross-section than a cross-section of the rim through a trough 116 of the undulating shape.

The undulating shape is optionally smooth. The undulating shape may be uniform or non-uniform. One example of a uniform undulating shape is a constant amplitude sinusoid superimposed on a circle. For example, a sinusoidal waveform having a constant amplitude may be mathematically superimposed on a circle to define an undulating shape such as that shown in the appended figures. More particularly, the peaks 114 and troughs 116 of a rim may conform to the sinusoidal waveform.

A constant amplitude waveform may refer to a waveform in which the height of each peak is substantially identical to each other peak. Stated another way, the top of each peak may be substantially the same distance from a center of the wheel (e.g., the rotational axis of the hub). Other symmetrical, constant amplitude waveforms may also be used other than sinusoidal waveforms.

As noted, the undulating shape may be a non-uniform shape, such as a shape where different peaks have different heights. For example, some peaks may be higher (relative to one or more adjacent troughs) than other peaks, or the peaks may be themselves asymmetrical (e.g., having a generally “saw tooth” or “ratchet” shape. An exemplary symmetric shape is formed by the same the slope or rate of change of cross-sectional area on both sides of a peak. In some cases, even where a non-uniform shape is used (such as where not all peaks have the same height), the wheel may be substantially radially symmetric.

In some aspects, each of the plurality of radially extending portions or peaks engages with a spoke, and the spokes join the peaks at the highest point of the peaks (e.g., the portion of a peak that is most proximal to a center of the wheel). (Optionally a spoke contacts a rim at a location other than the highest point of a peak (e.g., at the lowest point of the trough, and/or at any point between the highest and lowest points of the waveform)).

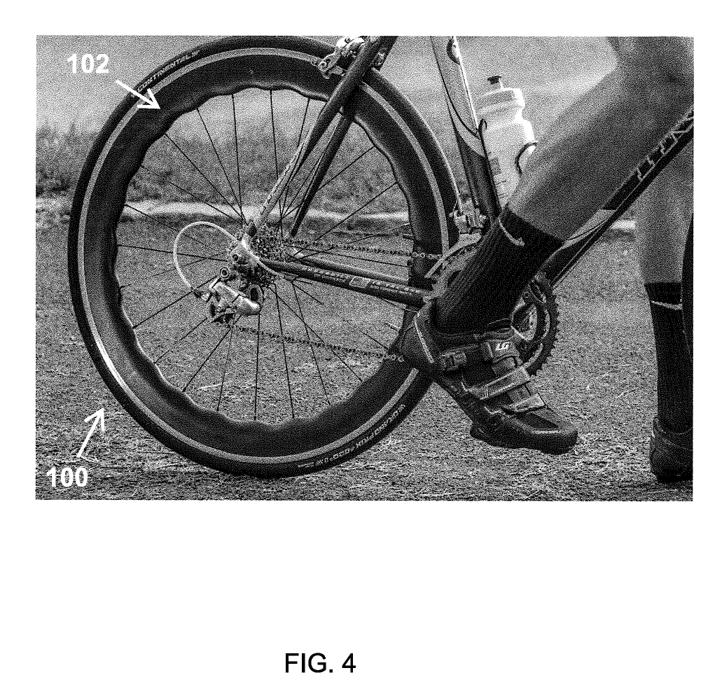

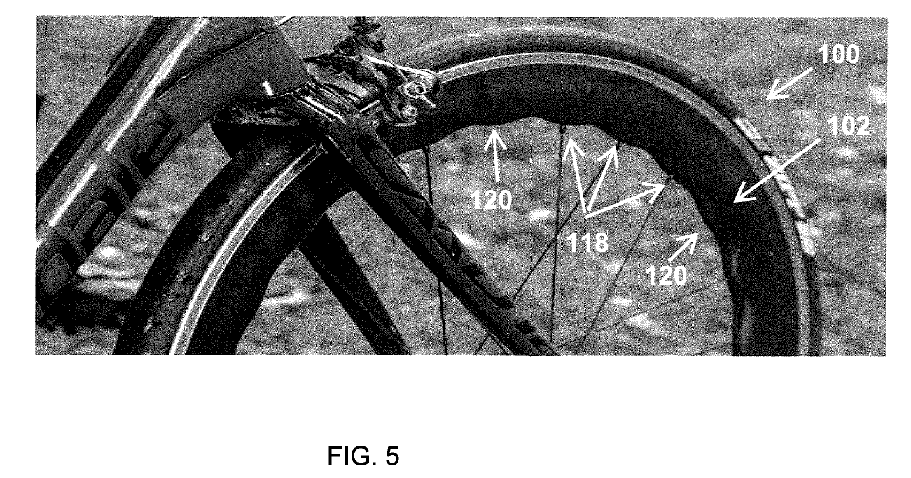

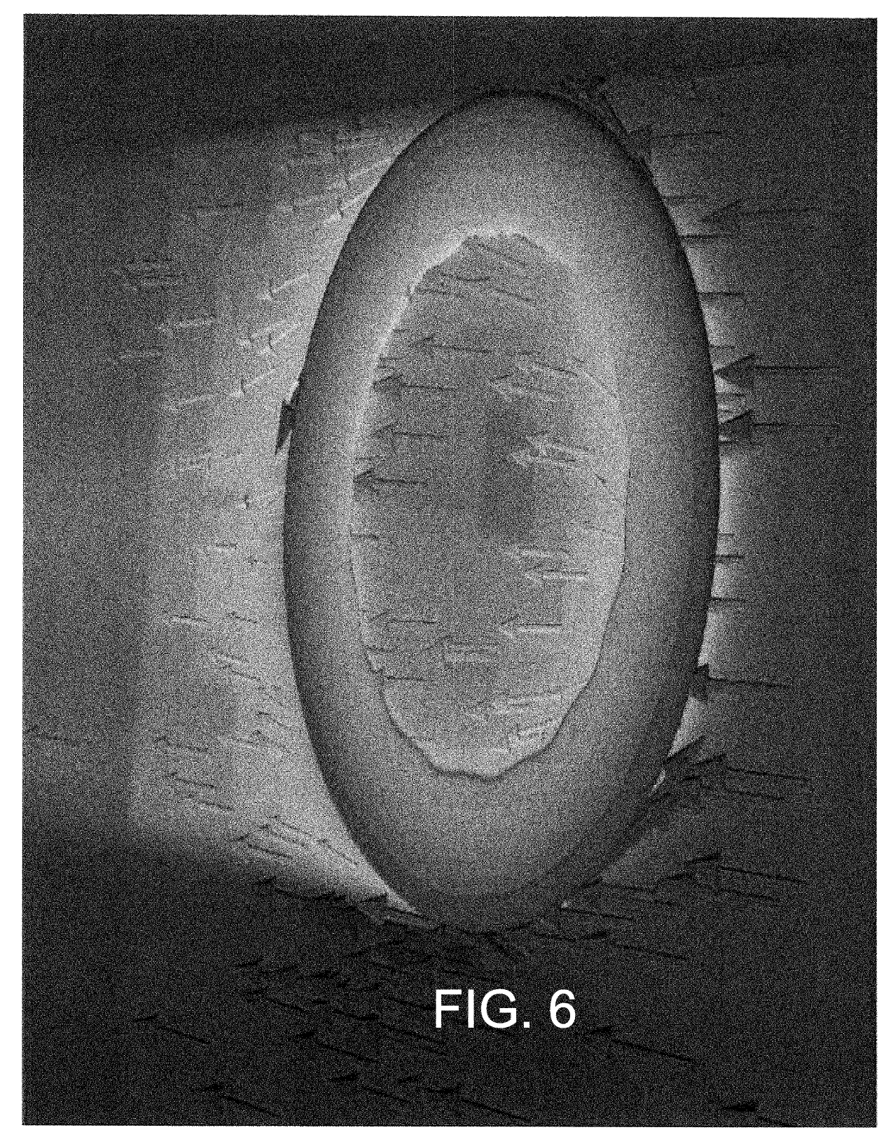

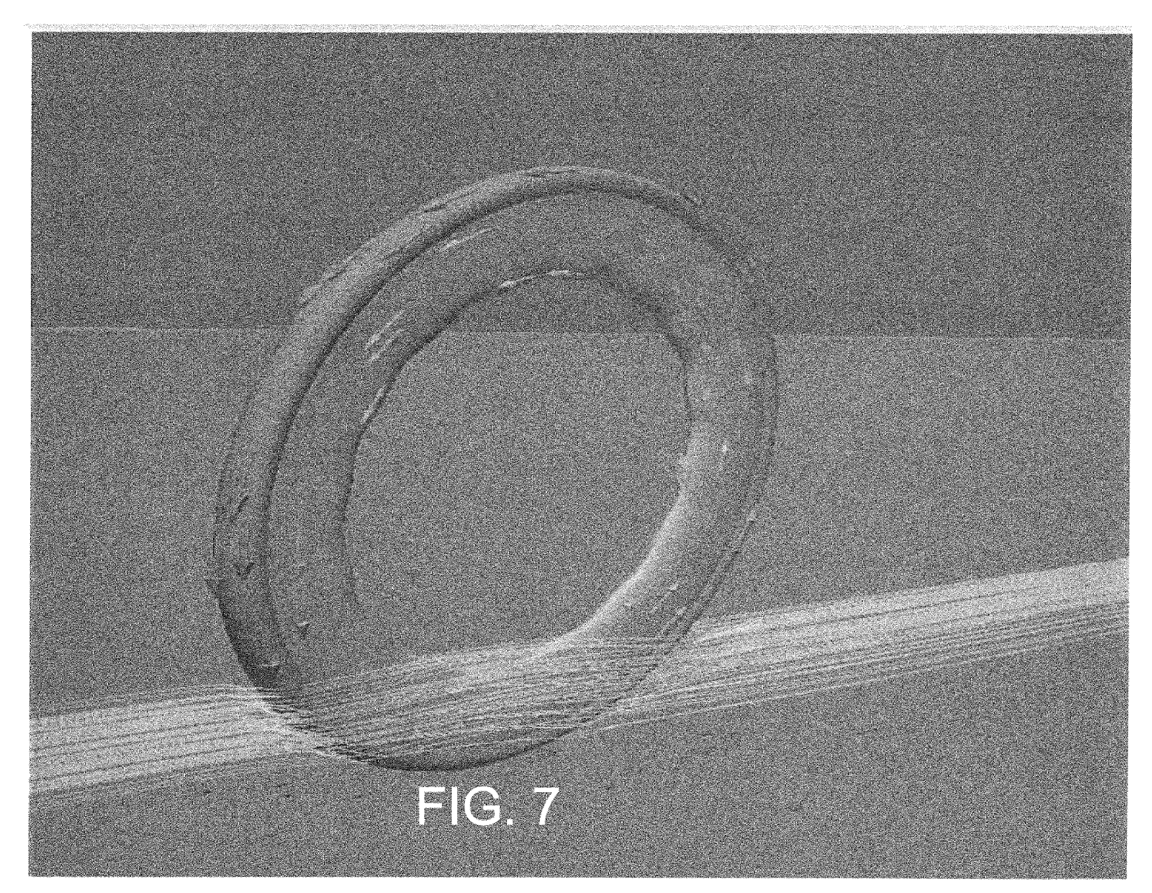

FIG. 4 shows an example of a wheel in which each peak is engaged with a corresponding spoke. (E.g., there are the same number of peaks as spokes.) In other aspects, not every peak is engaged with a spoke. In particular, a wheel may include fewer spokes than the number of peaks on the rim. For example, a wheel with 18 spokes may have 24 peaks, or a wheel with 12 spokes may have 24 peaks. In some cases, there is one unused peak (e.g., not engaged with a spoke) between neighboring groups of peaks to which spokes are engaged, while in other cases there are two, three, or four unused peaks between neighboring groups of peaks to which spokes are engaged. FIG. 5 shows an example of a wheel having fewer spokes than peaks, and in particular having groups of three spokes engaged with three adjacent peaks 118, with one unused peak 120 between each spoke group. Where a peak does not engage with a spoke, that peak may have substantially identical dimensions to the peaks that do engage with spokes. This may maintain the uniformity of the rim shape, and provide advantageous aerodynamic and/or strength properties (as compared to a rim with unused peaks having different dimensions than adjacent peaks that do engage with spokes). For example, the substantially uniform height of the peaks regardless of whether they are engaged with a spoke or not may increase the overall isotropy of the properties of the rim.

A variable cross-section may be defined or characterized by a height representing a distance between the highest part of a peak and the lowest part of a trough (e.g., twice the amplitude of the sinusoidal waveform that defines the undulating shape of the rim). The height is optionally about 1 millimeter (mm) or more, optionally about 2 mm or more, optionally about 3 mm or more, optionally about 4 mm or more, optionally about 5 mm or more, optionally about 6 mm or more, optionally about 7 mm or more, optionally about 8 mm or more, optionally about 9 mm or more, optionally about 10 mm or more. In some aspects a height is between about 1 mm and about 10 mm, optionally between about 5 mm and about 10 mm, optionally between about 7 mm and about 9 mm, or optionally between about 1 mm and about 4 mm.

The first and second sides of the rim optionally include one or more surface features that extend axially therefrom or represent depressions in the surface. Such depressions are optionally described in U.S. Pat. No. 7,114,785. In some aspects, one or more of the first or second sides excludes a surface feature extending either from or as a depression in the surface. It was unexpectedly found that by excluding features such as depressions from the two sides of the rim that improved performance may be achieved.

A rim is optionally formed of one or more materials known in the art. Optionally, a rim is formed of a core that may be hollow or substantially hollow, or may include foam, gel, or other material that is suitable for a core. Optionally, a honeycomb-shaped material or structure is used in the core. The core may be filled partially or wholly with a gas or may include a vacuum or other pressure of less than one atmosphere, optionally a gas with a density less than air. An outer surface of a rim or the rim itself is optionally made of a material such as metal or composite material or combinations of both. In some cases, the first and second surfaces of the rim (e.g., that form or define the undulating structure of the rim) comprise carbon fiber or another suitable composite material, while a tire engaging portion and optionally braking surface of the rim comprise aluminum, magnesium, ceramic, or another material. In some cases, the tire engaging portion and optionally braking surface are formed separately and then joined to one another. In other cases, the tire engaging portion, first and second surfaces, and braking surface are a unitary structure (e.g., they are formed by molding, laying up, or otherwise building a single structure from carbon fiber or any other suitable composite or other material). Other materials and combinations of materials are also contemplated.

A wheel optionally includes a hub. A hub is any hub known in the art suitable for connecting the rim to a bicycle, optionally through one or a plurality of spokes.

In operation, the wheel is connected to the bicycle at the center of rotation. A hub, which is part of the wheel assembly, connects to the bicycle, allowing the bicycle and rider to roll freely. In operation, the improved bicycle wheel with a variable cross-sectional profile rim, functions similar to current bicycle wheels. The tire and optional inner tube can be affixed to the rim in any method, including but not limited to, the current “clincher” and “tubular” methods.

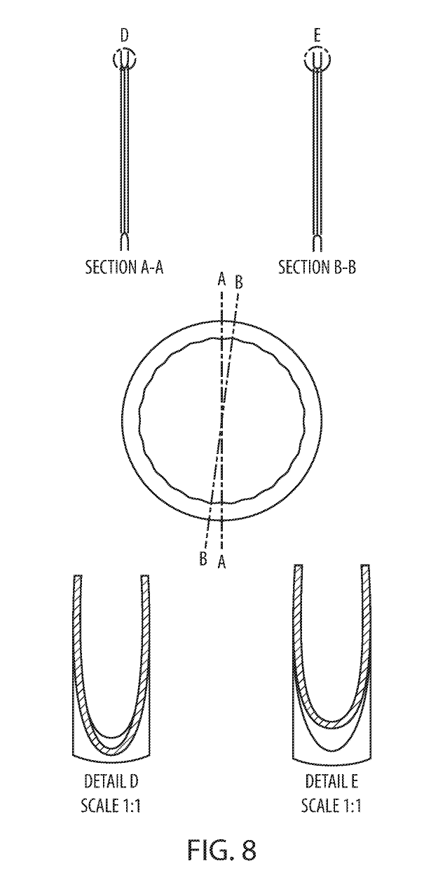

Example cross-sections of a variable cross-section rim in accordance with the instant disclosure is illustrated in FIG. 8. (The drawings in FIG. 8 are not necessarily to scale and are presented for illustrative and descriptive purposes.)

In FIG. 8, section view A-A shows a cross-sectional profile taken where the profile is at its maximum height (e.g., through the highest point of one of the peaks). Section view B-B shows the cross-sectional profile taken where the profile is at its minimum height (e.g., through the lowest point of one of the troughs), in this case, 7.5 degrees offset from Section View A-A. Detail D shows a close up of the cross-sectional profile taken at section view A-A, and Detail E shows a close up of the cross-sectional profile take at section view B-B. The variable height of the peaks and troughs is apparent from Details D and E. The shaded sections in both Detail D and Detail E show the cross-sectional profile at that given section.

Various modifications of the present invention, in addition to those shown and described herein, will be apparent to those skilled in the art of the above description. Such modifications are also intended to fall within the scope of the appended claims.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. Also, when used herein to refer to positions of components, the terms above and below, or their synonyms, do not necessarily refer to an absolute position relative to an external reference, but instead refer to the relative position of components with reference to the figures.

What is claimed is:

1. A wheel for a human powered vehicle, comprising:
a rim having a variable cross-section and comprising:
a first side defining a first inner edge and a first outer edge; and
a second side defining a second inner edge and a second outer edge, wherein the first inner edge and the second inner edge of the first and second sides, respectively, define a spoke engaging portion having a profile defined by a substantially sinusoidal waveform superimposed on a circle;
a hub; and
a plurality of spokes engaged with the spoke engaging portion and the hub to secure the variable cross-section rim to the hub.

2. The wheel of claim 1, wherein:
the spoke engaging portion defines peaks extending radially towards the hub; and
the peaks conform to the substantially sinusoidal waveform.

3. The wheel of claim 2, wherein the peaks have a height, relative to adjacent troughs, between about 1 mm and about 7 mm.

4. The wheel of claim 2, wherein the peaks have a height, relative to adjacent troughs, between about 1 mm and about 5 mm.

5. The wheel of claim 2, wherein the wheel comprises more peaks than spokes.

6. The wheel of claim 2, wherein the rim comprises carbon fiber.

7. The wheel of claim 2, wherein the first and second sides of the rim are part of a unitary carbon fiber structure.

8. The wheel of claim 7, further comprising a metal hoop defining a braking surface and configured to engage a tire.

9. The wheel of claim 2, wherein the spoke engaging portion defines 24 peaks of equal height.

10. The wheel of claim 9, wherein the wheel comprises 18 spokes.
